(19) United States
(12) Patent Application Publication
(10) Pub. No.: US 2026/0049229 A1
(43) Pub. Date: Feb. 19, 2026

(54) STRUCTURE CLADDING STRUCTURE, COATING COMPOSITION, AND METHOD FOR MANUFACTURING SAME

(71) Applicant: KEIWA Incorporated, Tokyo (JP)

(72) Inventors: Seiji ENDO, Gyoda-shi, Saitama (JP); Noriaki OTANI, Chuo-ku, Tokyo (JP); Yuki MATSUNO, Chuo-ku, Tokyo (JP)

(73) Assignee: KEIWA Incorporated, Tokyo (JP)

(21) Appl. No.: 19/103,159

(22) PCT Filed: Aug. 30, 2023
(86) PCT No.: PCT/JP2023/031509

§ 371 Date: Feb. 11, 2025

(30) Foreign Application Priority Data
Sep. 1, 2022 (JP) 2022-139294
Aug. 29, 2023 (JP) 2023-139057

(51) Int. Cl. C09D 133/10; B32B 7/12; B32B 27/30

(52) U.S. Cl. CPC C09D 133/10; B32B 7/12; B32B 27/308

(57) ABSTRACT

A coating composition is applied to a roof 2, and this coating composition is dried, whereby a primer layer 6 is obtained. This coating composition contains (1) a polymer including an alkyl (meth)acrylate ester monomer unit in the main chain, and (2) a partial reaction product of a mixture containing an epoxy compound and an aminosilane compound. Preferably, the amount of the partial reaction product (2) is 1 part by mass or more and 150 parts by mass or less with respect to 100 parts by mass of the polymer (1). Preferably, the ratio (Y/X) of the number (Y) of an amino group and/or an imino group in the aminosilane compound to the number (X) of an epoxy group in the epoxy compound in the mixture is 0.2 or more and 1.5 or less.

### TECHNICAL FIELD

The present specification discloses a coating composition that is applied to structures and the like.

### BACKGROUND ART

Artificial slate is commonly used for a residential roof.

When this slate roof is exposed to rain and wind for an extended period, deterioration occurs in the roof. Rain may leak through the slate roof that has deteriorated. A slate roof is coated with a coating material with the aim of preventing rain leakage. However, when the slate roof has severely deteriorated, rain leakage may not be prevented even by coating the roof with the coating material.

Japanese Patent Application Publication No. 2022-101896 discloses a method for repairing a roof with a sheet having a polymer cement layer and a resin layer. Pasting this sheet to a roof makes it possible to suppress rain leakage through the roof.

### CITATION LIST

### Patent Literature

PTL 1: Japanese Patent Application Publication No. 2022-101896

### SUMMARY OF INVENTION

### Technical Problem

Before the sheet is pasted to the roof, the coating material may be applied to this roof. A coating film obtained from this coating material is capable of functioning as a primer layer. This primer layer is capable of making the sheet firmly adhere to the roof. In other words, excellent bonding adhesion is required for the primer layer.

In the repair of roofs other than slate roofs, a primer layer with excellent bonding adhesion is required. Even in the repair or reinforcement of structures other than roofs, a primer layer with excellent bonding adhesion is required.

The present applicant's intention is to provide a coating composition from which a coating film with excellent bonding adhesion can be obtained.

### Solution to Problem

A coating composition that is disclosed by the present specification contains
(1) a polymer including an alkyl (meth)acrylate ester monomer unit in a main chain thereof, and
(2) a partial reaction product of a mixture containing an epoxy compound and an aminosilane compound.

### Advantageous Effects of Invention

A coating film that contributes to bonding adhesion can be obtained from this coating composition.

### BRIEF DESCRIPTION OF DRAWINGS

FIG. 1 is a front view showing a cladding structure according to one embodiment together with a roof.

FIG. 2 is an enlarged cross-sectional view along a II-II line in FIG. 1.

FIG. 3 is an enlarged cross-sectional view showing a part of a sheet included in the cladding structure of FIG. 1.

FIG. 4 is an enlarged plan view showing a part of a reinforcing body included in the sheet of FIG. 3.

### DESCRIPTION OF EMBODIMENTS

Preferred embodiments will be described in detail below with reference, as appropriate, to the figures.

### Cladding Structure

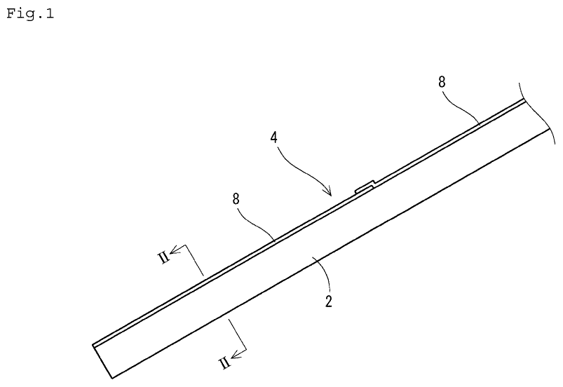

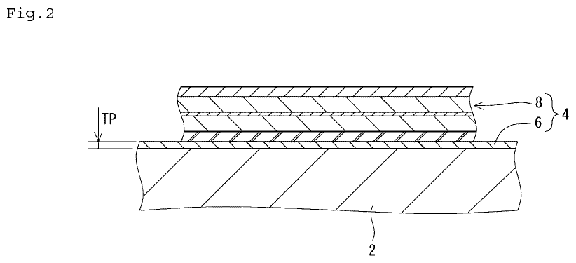

FIG. 1 shows a roof 2, which is a structure, and a cladding structure 4. As shown in FIG. 2, the cladding structure 4 has a primer layer 6 and a sheet 8. The cladding structure 4 clads the roof 2.

### Primer Layer

The primer layer 6 is formed by applying a coating composition to the roof 2 and drying this coating composition. The primer layer 6 is present between the roof 2 and the sheet 8. The primer layer 6 increases the degree of adhesion between the sheet 8 and the roof 2. The primer layer makes the sheet 8 firmly adhere to the roof 2. An arrow TP in FIG. 2 represents the thickness of the primer layer 6. From the viewpoint of the bonding adhesive force of the sheet 8 to the roof 2, the thickness TP is preferably 50 μm or more, more preferably 100 μm or more and particularly preferably 150 μm or more. From the viewpoint of ease of work, the thickness TP is preferably 500 μm or less, more preferably 400 μm or less and particularly preferably 350 μm or less.

The coating composition for the primer layer 6 contains
(1) a polymer including an alkyl (meth)acrylate ester monomer unit in the main chain, and
(2) a partial reaction product of a mixture containing an epoxy compound and an aminosilane compound.

The polymer (1) including an alkyl (meth)acrylate ester monomer unit in the main chain is a so-called acrylic polymer. The primer layer 6 obtained from this coating composition is capable of contributing to the initial bonding adhesion and long-term bonding adhesion of the sheet 8 to the roof 2. The initial bonding adhesion is bonding adhesion immediately after the sheet 8 is pasted to the roof 2. The long-term bonding adhesion is bonding adhesion when a long period of time elapses after the sheet 8 is pasted to the roof 2.

### Acrylic Polymer

“(Meth)acrylic acid” in the present specification means any one or both of acrylic acid and methacrylic acid. This polymer is obtained by a polymerization reaction of a monomer. This polymer includes a plurality of units. Each unit is derived from the monomer. In the present specification, this unit will be referred to as “monomer unit.” The polymer including an alkyl (meth)acrylate ester monomer unit in the main chain is capable of contributing to the bonding adhesion of the coating composition. This polymer is capable of contributing particularly to the bonding adhesion of artificial slate that has deteriorated to the roof 2. This polymer may include an alkyl (meth)acrylate ester monomer unit in a side chain as well as in the main chain. The coating composition may contain two or more kinds of acrylic polymers.

As the alkyl (meth)acrylate ester monomer, methyl (meth)acrylate, ethyl (meth)acrylate, n-propyl (meth)acrylate, n-butyl (meth)acrylate, isobutyl (meth)acrylate, tert-butyl (meth)acrylate, n-hexyl (meth)acrylate, heptyl (meth)acrylate, 2-ethylhexyl (meth)acrylate, nonyl (meth)acrylate, decyl (meth)acrylate, undecyl (meth)acrylate, lauryl (meth)acrylate, tridecyl (meth)acrylate, myristyl (meth)acrylate, cetyl (meth)acrylate, stearyl (meth)acrylate, behenyl (meth)acrylate and biphenyl (meth)acrylate are exemplified. The acrylic polymer may be obtained by a polymerization reaction of two or more kinds of monomers.

The acrylic polymer (1) may include a monomer unit other than the alkyl (meth)acrylate ester monomer unit in the main chain. As a monomer from which this unit is derived, monomers containing a carboxy group such as acrylic acid and methacrylic acid; monomers containing an amide group such as acrylamide, methacrylamide, N-methylol acrylamide and N-methylol methacrylamide; monomers containing an epoxy group such as glycidyl acrylate and glycidyl methacrylate; monomeric units containing an amino group such as diethylaminoethyl acrylate, diethylaminoethyl methacrylate and aminoethyl vinyl ether; polyoxyethylene acrylate; and polyoxyethylene methacrylate are exemplified. A copolymer of a monomer thereof and the alkyl (meth)acrylate ester monomer is capable of contributing to the curability of the coating composition.

The acrylic polymer (1) may include a monomer unit attributed to acrylonitrile, styrene, α-methylstyrene, alkyl vinyl ether, vinyl chloride, vinyl acetate, vinyl propionate, ethylene or the like in the main chain.

The proportion of the alkyl (meth)acrylate ester monomer unit in the copolymer of the alkyl (meth)acrylate ester monomer and a different monomer is preferably 50 mass % or more, more preferably 70 mass % or more and particularly preferably 80 mass % or more. The proportion may be 100 mass %.

The acrylic polymer (1) can be obtained by a vinyl polymerization method. Specifically, the acrylic polymer (1) can be obtained by a chain transfer agent method, a living radical polymerization method or the like. In the chain transfer agent method, polymerization is performed with a chain transfer agent having a specific functional group, and a polymer having a functional group at an end can be obtained. In the living radical polymerization method, a polymerization growth end grows without causing a termination reaction or the like, whereby a polymer having a molecular weight almost as designed can be obtained. In the living radical polymerization method, a termination reaction is less likely to occur, and a polymer having a narrow molecular weight distribution can be obtained (Mw/Mn is approximately 1.1 to 1.5). In the living radical polymerization method, a polymer having a low viscosity can be obtained. In the living radical polymerization method, a monomer having a specific functional group can be introduced into an arbitrary position of a polymer. This polymerization method is described in Japanese Patent Application Publication No. 2003-313397. Any of a solution polymerization method and a bulk polymerization method can be employed.

The polymerization reaction can be performed in a mixed solution of the monomer, a radical initiator, a chain transfer agent, a solvent and the like at a temperature of 50° C. to 150° C. As the radical initiator, azobisisobutyronitrile and benzoyl peroxide are exemplified. As the chain transfer agent, mercaptans such as n-dodecyl mercaptan, tert-dodecyl mercaptan and lauryl mercaptan; and halogen-containing compounds are exemplified. As the solvent, ethers, hydrocarbons and esters are exemplified.

The weight-average molecular weight of the acrylic polymer (1) is preferably 500 or higher and 100000 or lower. The polymerization reaction for this acrylic polymer (1) is easy. This polymer is excellent in terms of handleability and compatibility with other compounds. From these viewpoints, the weight-average molecular weight is more preferably 1000 or higher and 50000 or lower and particularly preferably 2000 or higher and 30000 or lower. This molecular weight is measured by gel permeation chromatography (in terms of polystyrene).

### Partial Reaction Product

As described above, the coating composition contains the partial reaction product (2) of a mixture containing an epoxy compound and an aminosilane compound. This partial reaction product (2) is capable of playing a role of a compatibilizer and a bonding adhesion promotor. Furthermore, this partial reaction product (2) is also capable of contributing to the stabilization of the adhesive strength. The coating composition containing this partial reaction product (2) is capable of contributing to the bonding adhesion of the primer layer 6.

### Epoxy Compound

As the epoxy compound, glycidyl ether-type compounds obtained by a reaction between a polyhydric phenol such as bisphenol A, bisphenol F, bisphenol S, hexahydrobisphenol A, tetramethylbisphenol A, pyrocatechol, resorcinol, cresol novolak, tetrabromobisphenol A, trihydroxybiphenyl, bisresorcinol, bisphenol hexafluoroacetone, tetramethyl bisphenol F or bixylenol and epichlorohydrin; polyglycidyl ether-type compounds obtained by a reaction between an aliphatic polyhydric alcohol such as glycerin, neopentyl glycol, ethylene glycol, propylene glycol, butylene glycol, hexylene glycol, polyethylene glycol or polypropylene glycol and epichlorohydrin; glycidyl ether ester-type compounds obtained by a reaction between a hydroxycarboxylic acid such as p-oxybenzoic acid or β-oxynaphthoic acid and epichlorohydrin; polyglycidyl ester-type compounds that are derived from polycarboxylic acid such as phthalic acid, methylphthalic acid, isophthalic acid, terephthalic acid, tetrahydrophthalic acid, hexahydrophthalic acid, endomethylenetetrahydrophthalic acid, endomethylenehexahydrophthalic acid, trimellitic acid or a polymerized fatty acid; glycidyl aminoglycidyl ether-type compounds that are derived from aminophenol or aminoalkylphenol; glycidyl aminoglycidyl ester-type compounds that are derived from aminobenzoic acid; and glycidyl amine-type compounds that are derived from aniline, toluidine, tribromoaniline, xylylenediamine, diaminocyclohexane, bisaminomethylcyclohexane, 4,4′-diaminodiphenylmethane or 4,4′-diaminodiphenylsulfone are exemplified. As the epoxy compound, furthermore, epoxidized polyolefins, glycidyl hydantoin, glycidyl alkyl hydantoin and triglycidyl cyanurate are exemplified. As the epoxy compound, furthermore, monoepoxy compounds such as butyl glycidyl ether, phenyl glycidyl ether, alkylphenyl glycidyl ether, benzoic acid glycidyl ester and styrene oxide are exemplified. The epoxy compound may be a polymer of a compound including two or more epoxy groups in the molecule. The partial reaction product (2) may be derived from two or more kinds of epoxy compounds.

An aliphatic epoxy compound is preferable. Examples of this epoxy compound include the above-described glycidyl ether-type compounds obtained by a reaction between a polyhydric phenol and epichlorohydrin. This epoxy compound has excellent reactivity at low temperatures. This epoxy compound is capable of contributing to the adhesive strength and weather resistance of the primer layer 6. The aliphatic epoxy compound includes at least one aliphatic ring other than aromatic rings in one molecule and includes at least one epoxy group. From the viewpoint of easy procurement, an epoxy compound containing sorbitol, glycerin, diglycerin or polyglycerin as the mother skeleton is preferable.

### Aminosilane Compound

A preferred aminosilane compound has at least one of an amino group and/or an imino group and at least one hydrolysable silicon-containing group. As the aminosilane compound, Υ-aminopropyltrimethoxysilane, Υ-aminopropyltriethoxysilane, Υ-aminopropylmethyldimethoxysilane, Υ-aminopropylethyldiethoxysilane, bistrimethoxysilylpropylamine, bistriethoxysilylpropylamine, bismethoxydimethoxysilylpropylamine, bisethoxydiethoxysilylpropylamine, N-β (aminoethyl) Υ-aminopropyltrimethoxysilane, N-β (aminoethyl) Υ-aminopropylmethyldimethoxysilane, N-β (aminoethyl) Υ-aminopropyltriethoxysilane, N-β (aminoethyl) Υ-aminopropylethyldiethoxysilane, 3,3-dimethyl-4-aminobutyltrimethoxysilane, 3,3-dimethyl-4-aminobutylmethyldimethoxysilane, (N-cyclohexylaminomethyl)methyldiethoxysilane, (N-cyclohexylaminomethyl) triethoxysilane, (N-phenylaminomethyl)methyldimethoxysilane and (N-phenylaminomethyl)trimethyloxysilane are exemplified.

As preferred other aminosilane compounds, compounds having a structure represented by the following formula (I) and compounds having a structure represented by the following formula (II) are exemplified.

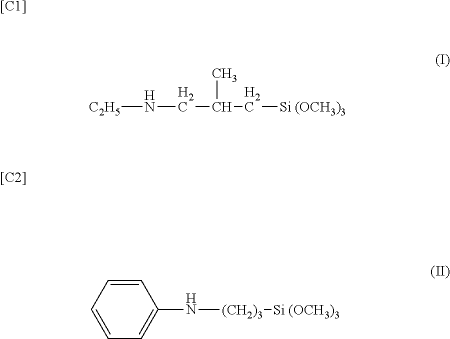

The partial reaction product (2) may be derived from two or more kinds of aminosilane compounds.

### Mixture

The ratio (Y/X) of the number (Y) of amino groups and/or imino groups in the aminosilane compound to the number (X) of epoxy groups in the epoxy compound in the mixture for the partial reaction product (2) is preferably 0.2 or more and 1.5 or less. This ratio (Y/X) is more preferably 0.4 or more and particularly preferably 0.5 or more. This (Y/X) is more preferably 1.3 or less and particularly preferably 1.2 or less.

The mixture for the partial reaction product (2) may contain a compound other than the epoxy compound and the aminosilane compound. As a preferred compound, alkoxysilane-containing epoxy compounds are exemplified. The alkoxysilane-containing epoxy compound has excellent compatibility with the reaction product of the epoxy compound and the aminosilane compound. This alkoxysilane-containing epoxy compound is capable of functioning as an accelerator of moisture curability in the coating composition. This alkoxysilane-containing epoxy compound is capable of contributing to the curability of the coating composition. The partial reaction product (2) containing the alkoxysilane-containing epoxy compound is suitable for long-term preservation. Furthermore, the primer layer 6 that is obtained from this coating composition is capable of suppressing the scattering of dust derived from the roof 2 when the sheet 8 has been peeled off from the roof 2. In other words, this primer layer 6 has an excellent sealing property.

As the alkoxysilane-containing epoxy compound, 3-glycidoxypropylmethyldimethoxysilane, 3-glycidoxypropyltrimethoxysilane, 3-glycidoxypropylmethyldiethoxysilane and 3-glycidoxypropyltriethoxysilane are exemplified.

The proportion of the amount of the alkoxysilane-containing epoxy compound in the total amount of the epoxy compound, the aminosilane compound and the alkoxysilane-containing epoxy compounds in the mixture is preferably 10 mass % or more and 40 mass % or less in terms of the solid content. This proportion is more preferably 15 mass % or more and particularly preferably 20 mass % or more. This proportion is more preferably 35 mass % or less and particularly preferably 30 mass % or less.

The mixture containing the epoxy compound and the aminosilane compound is subjected to a known reaction. The progress of the reaction between the epoxy compound and the aminosilane compound generates a reaction product, which may cause the gelation of the mixture. The partial reaction product (2) can be obtained by terminating the reaction in a stage where this gelation does not occur. As a method for terminating the reaction, dilution of the mixed solution with a solvent such as ethanol is exemplified.

The gel fraction in the partial reaction product (2) is preferably 15% or more and 85% or less. A coating composition with an excellent sealing property can be obtained from the partial reaction product (2) having a gel fraction of 15% or more. From this viewpoint, the gel fraction is more preferably 30% or more and particularly preferably 35% or more. A coating composition having an appropriate viscosity can be obtained from the partial reaction product (2) having a gel fraction of 85% or less. From this viewpoint, the gel fraction is more preferably 70% or less and particularly preferably 60% or less.

### Coating Composition

As described above, the coating composition contains
(1) the polymer including the alkyl (meth)acrylate ester monomer unit in the main chain, and
(2) the partial reaction product of the mixture containing the epoxy compound and the aminosilane compound.

The amount of the partial reaction product (2) is preferably 1 part by mass or more and 150 parts by mass or less with respect to 100 parts by mass of the acrylic polymer (1). The primer layer 6 that makes the pasting work of the sheet 8 easy can be obtained from this coating composition.

From this viewpoint, the amount of the partial reaction product (2) is more preferably 30 parts by mass or more and particularly preferably 50 parts by mass or more.

The coating composition may contain an organic solvent. The amount of the organic solvent is preferably 250 parts by mass or more and 400 parts by mass or less with respect to 100 parts by mass of the acrylic polymer (1).

The coating composition may contain a silane coupling agent. The silane coupling agent is capable of contributing to the bonding adhesion of the primer layer 6. The silane coupling agent includes at least one functional group that is reactive with an organic group in the molecule of the partial reaction product (2). The silane coupling agent further includes at least one hydrolysable silicon group. As this functional group, a methacrylic group, an acrylic group, an isocyanate group, an isocyanurate group, a vinyl group, a carbamate group and an epoxy group are exemplified. The silane coupling agent may include two or more kinds of functional groups. From the viewpoint of the curability of the coating composition and the bonding adhesion of the primer layer 6, a methacrylic group, an acrylic group and an epoxy group are preferable. From the viewpoint of handleability, a preferred hydrolysable silicon group is an alkoxysilyl group.

From the viewpoint of reactivity, a particularly preferred hydrolysable silicon group is a methoxysilyl group and an ethoxysilyl group.

As a preferred silane coupling agent, alkoxysilanes having a methacrylic group or an acrylic group such as Υ-methacryloxypropyltrimethoxysilane, Υ-methacryloxypropyltriethoxysilane, Υ-acryloxypropyltrimethoxysilane, Υ-acryloxypropyltriethoxysilane, methacryloxymethyltrimethoxysilane, methacryloxymethyltriethoxysilane, acryloxymethyltrimethoxysilane and acryloxymethyltriethoxysilane; and epoxy group-containing silane compounds such as Υ-glycidoxypropyltrimethoxysilane, Υ-glycidoxypropyltriethoxysilane, Υ-glycidoxypropylmethyldimethoxysilane, β-(3,4-epoxycyclohexyl)ethyltrimethoxysilane and Υ-glycidoxypropylmethyldiethoxysilane.

From the viewpoint of bonding adhesion, the amount of the silane coupling agent is preferably 1 part by mass or more with respect to 100 parts by mass of the acrylic polymer (1). From the viewpoint of the physical properties of the primer layer 6, this amount is preferably 100 parts by mass or less and particularly preferably 50 parts by mass or less.

The coating composition may contain a reinforcing agent. The reinforcing agent is capable of contributing to the strength of the primer layer 6. Examples of the reinforcing agent include organic fine particles and inorganic fine particles. From the viewpoint of heat resistance, inorganic fine particles are preferable. As a material of the inorganic particle, silica, titania, alumina, zirconia, ceria and calcium carbonate are exemplified.

From the viewpoint of the strength of the primer layer 6, the amount of the reinforcing agent is preferably 1 part by mass or more with respect to 100 parts by mass of the acrylic polymer (1). From the viewpoint of the bonding adhesion of the primer layer 6, this amount is preferably 100 parts by mass or less and particularly preferably 60 parts by mass or less.

From the viewpoint of the transparency of the primer layer 6, the particle diameter of the reinforcing agent is preferably 1.0 μm or less and particularly preferably 0.5 μm or less. From the viewpoint of transparency, a reinforcing agent having a refractive index that is substantially equal to the refractive index of the matrix is preferable.

The coating composition may further contain a different polymer. The coating composition may also contain a different additive. As the additive, a reaction retarder, an anti-aging agent, an antioxidant, a pigment, a dye, a plasticizer, a thixotropic agent, an UV absorber, a flame retardant, a solvent, a surfactant, a leveling agent, a dispersant, a dehydrating agent, a tackifier, an antistatic agent and a filler are exemplified.

This coating composition is excellent in terms of curability, pot life and workability. The primer layer 6 with excellent initial bonding adhesion, long-term bonding adhesion, sealing property and insect repellency can be obtained from this coating composition.

### Method for Manufacturing Coating Composition

The coating composition can be obtained by stirring a mixed solution of a solution or dispersion liquid containing the acrylic polymer (1) and a solution or dispersion liquid containing the partial reaction product (2). For the stirring, a stirring device such as a ball mill can be used. This stirring disperses a solid content in a solvent. A typical solvent is ethanol. To the mixed solution, an additive may be added together with the solvent such as ethyl benzene.

### Sheet

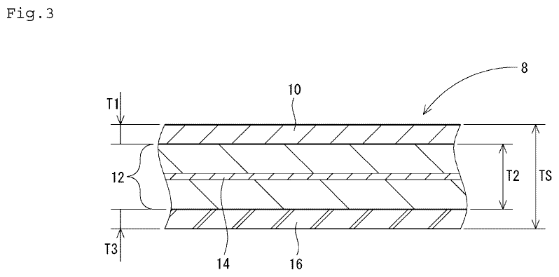

As shown in FIG. 3, the sheet 8 has a functional layer 10, an intermediate layer 12, an adhesive layer 14 and a reinforcing body 16. The reinforcing body 16 is embedded in the intermediate layer 12.

### Functional Layer

As is evident from FIG. 3, in the present embodiment, the functional layer 10 is positioned uppermost in the sheet 8. In other words, when the sheet 8 has been pasted to the structure, the functional layer 10 is positioned furthest away from this structure in the thickness direction. The functional layer 10 contributes to functions desired of the sheet 8. As these functions, weather resistance, abrasion resistance, chemical resistance, water impermeability, moisture impermeability, and moisture permeability are exemplified. Typical weather resistance is heat resistance and lightfastness. The functional layer 10 is capable of contributing to one or two or more functions.

A preferred material of the functional layer 10 is a polymer composition. The functional layer 10 is generally flexible. The sheet 8 having the functional layer 10 is capable of conforming to unevenness on the roof 2. The polymer composition contains a base polymer. A synthetic resin, synthetic rubber, and natural rubber can be included in the composition as the base polymer. As a preferred base polymer, an acrylic resin, an acrylic urethane resin, an acrylic silicone resin, a fluorine resin, a flexible epoxy resin, and polybutadiene are exemplified. When the base polymer is a synthetic resin, the functional layer 10 is also referred to as a “resin layer.”

From the viewpoint of lightfastness, an acrylic silicone resin is a resin that is particularly suitable as the base polymer of the functional layer 10. The acrylic silicone resin has a siloxane bond. Acrylic silicone resin is also excellent in terms of heat resistance and cold resistance. Specific examples of a composition containing the acrylic silicone resin include product name “COOL LIFE SP Black (CB1) P5-0” manufactured by Dainichiseika Color & Chemicals Mfg. Co., Ltd., product name “Belle Earth Elastic Black” manufactured by Fujikura Kasei Co., Ltd., product name “ARONBULLCOAT T-1000” manufactured by Toagosei Co., Ltd., and product names “ACRYSET EMN-325E” and “UWR EF-008”, manufactured by NIPPON SHOKUBAI CO., LTD..

The polymer composition of the functional layer 10 may contain additives such as a pigment, a filler, a reinforcing material, and a stain-resistant agent, as required. The functional layer 10 containing a pigment has excellent designability. The polymer composition may contain an organic pigment and an inorganic pigment. As the filler, metal oxide particles such as silica, alumina, and titania are exemplified. As the reinforcing material, a cellulose nanofiber is exemplified. The content of each of the additives is adjusted depending on the function.

An arrow T1 in FIG. 3 represents the thickness of the functional layer 10. From the viewpoint of functionality, the thickness T1 is preferably 10 μm or more, more preferably 30 μm or more and particularly preferably 50 μm or more. From the viewpoints of the conformability, productivity, and light weight of the sheet 8, the thickness T1 is preferably 500 μm or less, more preferably 300 μm or less and particularly preferably 150 μm or less. The distribution of the thickness T1 is preferably within a range of ±50 μm. The sheet 8 may include two or more functional layers 10.

### Intermediate Layer

The intermediate layer 12 contributes to the rigidity and the like of the sheet 8. A preferred material of the intermediate layer 12 is a composite material of a polymer and a filler. As the polymer of the composite material, an acrylic resin, an acrylic silicone resin, a fluorine resin, a silicone resin, an epoxy resin, an ethylene-vinyl acetate copolymer, and a styrene-butadiene copolymer are exemplified. As the filler of the composite material, cement, silica, alumina, titanium oxide, calcium carbonate, and carbon black are exemplified. A preferred composite material is polymer cement. This polymer cement includes a polymer and cement. The cement is in a state of being dispersed in the matrix of the polymer. The polymer is typically an acrylic resin. As the cement, Portland cement, alumina cement, and a mixture thereof are exemplified. Portland cement is preferable. The intermediate layer 12 that is made of polymer cement is also referred to as a “polymer cement cured layer.”

When the intermediate layer 12 contains a polymer and cement, the mass ratio of the polymer to the solid content of the intermediate layer 12 is preferably 10% or more and 40% or less. When this ratio is 10% or more, the intermediate layer 12 has excellent adhesion to the other layers (the functional layer 10 or the adhesive layer 148). From this viewpoint, this ratio is more preferably 15% or more and particularly preferably 20% or more. When this ratio is 40% or less, the intermediate layer 12 may contain a sufficient amount of cement. From this viewpoint, this ratio is more preferably 35% or less and particularly preferably 30% or less.

When the intermediate layer 12 contains a polymer and cement, the mass ratio of the cement to the solid content of the intermediate layer 12 is preferably 20% or more and 70% or less. When this ratio is 20% or more, a high tensile strength and low elongation can be achieved in the sheet 8 including the intermediate layer 12. This sheet 8 has excellent handleability. From this viewpoint, this ratio is more preferably 30% or more and particularly preferably 35% or more. When this ratio is 70% or less, the intermediate layer 12 may contain a sufficient amount of the polymer. From this viewpoint, this ratio is more preferably 60% or less and particularly preferably 55% or less.

The intermediate layer 12 can be formed from a mixed solution obtained from a composition containing a polymer and a composition containing cement. A preferred composition containing a polymer is an acrylic emulsion. This acrylic emulsion can be obtained by the emulsion polymerization of a monomer. The emulsion polymerization can be performed using an emulsifier. The polymerization can be performed in water containing a surfactant. The monomer is typically an acrylic acid ester or a methacrylic acid ester. The content of the monomer component of the acrylic emulsion is preferably 20 mass % to 100 mass %.

Specific examples of the composition containing a polymer include product name “Spring Coat Brush Mixed Solution” manufactured by KIKUSUI Chemical Industries Co., Ltd., and product name “ARONBULLCOAT A450 Base” manufactured by Toagosei Co., Ltd.. Specific examples of the composition containing cement include product name “Spring Coat Brush Powder” manufactured by KIKUSUI Chemical Industries Co., Ltd., and product name “ARONBULLCOAT A450 Setter” manufactured by Toagosei Co., Ltd..

The intermediate layer 12 containing a polymer and cement has an excellent water vapor transmission property. Thus, when the structure is covered by the sheet 8 including this intermediate layer 12, metal in this structure is less likely to corrode. The water vapor transmittance of the intermediate layer 12 is preferably 20 g/m²-day or more and 60 g/m²·day or less. The water vapor transmittance is measured in accordance with the prescriptions in “JIS Z0208.”

An arrow T2 in FIG. 3 represents the thickness of the intermediate layer 12. In the present embodiment, as described above, the reinforcing body 16 is embedded in the intermediate layer 12. Accordingly, the thickness T2 is measured so as to include the reinforcing body 16. From the viewpoint of the handleability of the sheet 8, the thickness T2 is preferably 100 μm or more, more preferably 300 μm or more and particularly preferably 500 μm or more. From the viewpoints of the conformability, productivity, and light weight of the sheet 8, the thickness T2 is preferably 1500 μm or less, more preferably 1000 μm or less and particularly preferably 700 μm or less. The distribution of the thickness T2 is preferably within a range of ±100 μm.

The material of the intermediate layer 12 may be a resin composition or a rubber composition. The sheet 8 may include two or more intermediate layers 12. The sheet 8 may include two intermediate layers 12 of different materials. The sheet 8 may have a layer structure that does not include the intermediate layer 12.

From the viewpoint of the adhesiveness of the intermediate layer 12 to the functional layer 10, a base polymer of the intermediate layer 12 is preferably the same kind as the base polymer of the functional layer 10.

### Adhesive Layer

The adhesive layer 14 (or bonding adhesive layer) is in contact with the primer layer 6. The sheet 8 can be pasted to the structure by the adhesive force of the adhesive layer 14.

A preferred material of the adhesive layer 14 is an adhesive composition containing a polymer as a base material. As a polymer suitable for this adhesive composition, an acrylic resin, silicone, polyurethane, polyester, natural rubber, and synthetic rubber are exemplified. An acrylic resin is a particularly preferable polymer for the base material. Specific examples of the adhesive composition include product names “ORIBAIN BPS 6574”, “ORIBAIN BPS 6554”, and “ORIBAIN BPS 5565K” manufactured by TOYOCHEM CO., Ltd. From the viewpoint of the adhesiveness of the adhesive layer 14 to the intermediate layer 12, the base polymer of the adhesive layer 14 is preferably the same kind as the base polymer of the intermediate layer 12. From the viewpoint of the adhesiveness of the adhesive layer 14 to the primer layer 6, the base polymer of the adhesive layer 14 is preferably the same kind as the base polymer of the primer layer 6.

The adhesive composition may contain a curing agent. As a preferred curing agent, an isocyanate-based curing agent, an amine-based curing agent, an epoxy-based curing agent and a metal chelate-based curing agent are exemplified. When the base material is an acrylic resin, a preferred curing agent is an isocyanate curing agent. The ratio of the isocyanate curing agent to 100 parts by mass of the acrylic resin is preferably 1.0 part by mass or more, more preferably 2.0 parts by mass or more and particularly preferably 2.5 parts by mass or more. This ratio is preferably 10 parts by mass or less, more preferably 8 parts by mass or less and particularly preferably 7 parts by mass or less.

The adhesive composition may contain a tackifier. As the tackifier, a rosin-based tackifier, a terpene-based tackifier, a petroleum resin-based tackifier, and a phenolic resin-based tackifier are exemplified. The ratio of the tackifier to 100 parts by mass of the base polymer is preferably 0.5 parts by mass or more, more preferably 1.0 part by mass or more and particularly preferably 1.5 parts by mass or more. This ratio is preferably 15 parts by mass or less, more preferably 10 parts by mass or less and particularly preferably 7 parts by mass or less. Specific examples of the tackifier include product names “ESTER GUM H”, “ESTER GUM AA-V”, and “ESTER GUM 105” manufactured by ARAKAWA CHEMICAL INDUSTRIES, LTD.

An arrow T3 in FIG. 3 represents the thickness of the adhesive layer 14. From the viewpoint of adhesion, the thickness T3 is preferably 20 μm or more, more preferably 40 μm or more and particularly preferably 50 μm or more. From the viewpoints of the productivity, light weight, and handleability of the sheet 8, the thickness T3 is preferably 500 μm or less, more preferably 200 μm or less and particularly preferably 150 μm or less. The amount of the adhesive layer 14 is preferably 20 g/m² or more and 250 g/m² or less. The sheet 8 may include two or more adhesive layers 14.

### Reinforcing Body (Reinforcement)

The reinforcing body 16 is capable of imparting an appropriate Young's modulus to the sheet 8. The reinforcing body 16 is capable of contributing to the large tensile strength of the sheet 8. Furthermore, the reinforcing body 16 is capable of contributing to the small elongation of the sheet 8. The sheet 8 including the reinforcing body 16 has excellent handleability. As described above, the reinforcing body 16 is embedded in the intermediate layer 12. The reinforcing body 16 may also be embedded in the functional layer 10. The reinforcing body 16 may also be embedded in the adhesive layer 14. The reinforcing body 16 may be positioned between the functional layer 10 and the intermediate layer 12. The reinforcing body 16 may be positioned between the intermediate layer 12 and the adhesive layer 14. In the present specification, the reinforcing body 16 means an object capable of imparting a large tensile strength to the sheet 8 in comparison with an imaginary sheet having an identical layer structure to the layer structure of the sheet 8 except for not including this reinforcing body 16.

The tensile strength of this reinforcing body 16 is preferably 5.0 MPa or higher. When the tensile strength of the reinforcing body 16 is 5.0 MPa or higher, the sheet 8 is less likely to break even when tension is applied thereto. This sheet 8 has excellent handleability. From this viewpoint, the tensile strength is more preferably 5.5 MPa or higher and particularly preferably 6.0 MPa or higher. From the viewpoint of the conformability of the sheet 8, the tensile strength of the reinforcing body 16 is preferably 15.0 MPa or lower, more preferably 10.0 MPa or lower and particularly preferably 7.0 MPa or lower.

The elongation at break of this reinforcing body 16 is preferably 15.0% or less. When the elongation of the reinforcing body 16 is 15.0% or less, the sheet 8 is less likely to deform even when tension is applied thereto. This sheet 8 has excellent handleability. From this viewpoint, the elongation of the reinforcing body 16 is more preferably 13.0% or less and particularly preferably 11.0% or less. From the viewpoint of the conformability of the sheet 8, the elongation of the reinforcing body 16 is preferably 5.0% or more, more preferably 7.0% or more and particularly preferably 8.5% or more.

The tensile strength and the elongation are measured in accordance with Test methods for nonwovens prescribed in “JIS L1913: 2010.” A test piece for the measurement is cut out from the reinforcing body 16 or an original fabric thereof. Five test pieces in which the length direction matches the length direction of the reinforcing body 16 or the original fabric thereof and five test pieces in which the length direction matches the width direction of the reinforcing body 16 or the original fabric thereof are used in the measurement. The tensile strength and the elongation are calculated by averaging ten measurement values.

The ratio of the area of the contour of the reinforcing body 16 to the area of the sheet 8 in a plan view is preferably 60% or more. When this ratio is 60% or more, the reinforcing body 16 is capable of contributing to the handleability of the sheet 8. From this viewpoint, this ratio is more preferably 70% or more and particularly preferably 75% or more. The ratio may be 100%. From the viewpoint of the conformability to a level difference of the sheet 8, this ratio is preferably 95% or less.

### Fabric

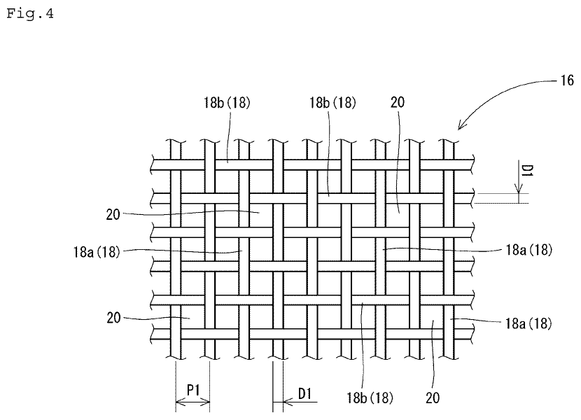

FIG. 4 shows the reinforcing body 16. In this reinforcing body 16, a plurality of warp threads 18a and a plurality of weft threads 18b are woven. In other words, the reinforcing body 16 is a woven fabric (cloth). In the present embodiment, this woven fabric has a plain weave structure. The woven fabric is a kind of fabric. The reinforcing body 16, which is a fabric, can be impregnated with the composition of the intermediate layer 12. This impregnation can contribute to the large tensile strength of the sheet 8. This impregnation can also contribute to the small elongation of the sheet 8. The reinforcing body 16 may be a fabric other than woven fabrics. As the fabric other than woven fabrics, a knitted fabric (knit) and an intersection welded mesh are exemplified.

As a material of the reinforcing body 16, a synthetic resin composition and a metal are exemplified. As a preferred base material resin for the synthetic resin composition, polyethylene terephthalate, polyethylene naphthalate, aramid, vinylon, polypropylene, polystyrene, and polyvinylidene fluoride are exemplified. As a preferred metal, an aluminum alloy, carbon steel, and alloy steel are exemplified. A sufficiently high tensile strength of the sheet 8 can be achieved by employing the warp threads 18a and weft threads 18b which have a high tensile strength. Sufficiently low elongation of the sheet 8 can be achieved by employing the warp threads 18a and weft threads 18b which have small elongation.

As is evident from FIG. 4, this reinforcing body 16 includes a large number of meshes 20. In the present embodiment, each of the meshes 20 has a substantially square planar shape. The intermediate layer 12 penetrates the meshes 20. This penetration can contribute to the large tensile strength of the sheet 8. This penetration can also contribute to the small elongation of the sheet 8.

An arrow P1 in FIG. 4 represents the pitch of the threads 18. The pitch P1 is preferably 1.2 mm or more and 50 mm or less. When the pitch P1 is 1.2 mm or more in the reinforcing body 16, the reinforcing body 16 is sufficiently impregnated with the composition of the intermediate layer 12. This reinforcing body 16 is capable of contributing to the large tensile strength and small elongation of the sheet 8. From this viewpoint, the pitch P1 is more preferably 1.5 mm or more and particularly preferably 1.7 mm or more. When the pitch P1 is 50 mm or less in the reinforcing body 16, this reinforcing body 16 is capable of contributing to the large tensile strength and small elongation of the sheet 8. From this viewpoint, the pitch P1 is more preferably 40 mm or less and particularly preferably 35 mm or less.

An arrow D1 in FIG. 4 represents the thickness of the thread 18. The threads 18 with a large thickness D1 make it possible to achieve the high tensile strength and small elongation of the sheet 8. From this viewpoint, the thickness D1 is preferably 0.05 mm or more, more preferably 0.10 mm or more and particularly preferably 0.15 mm or more. The thickness is preferably 1.0 mm or less.

The sheet 8 may include a non-fabric reinforcing body 16. As the non-fabric reinforcing body 16, nonwoven fabric, long fibers, a resin film, and a metal foil are exemplified. The reinforcing body 16 may also be a large number of short fibers dispersed in a composition. The sheet 8 may have a layer structure that does not include the reinforcing body 16.

### Different Layer

The sheet 8 may include a different layer that is positioned on the functional layer 10. A typical different layer is a clear paint layer. The sheet 8 may also include a layer that is positioned between the functional layer 10 and the intermediate layer 12. The sheet 8 may also include a layer that is positioned between the intermediate layer 12 and the adhesive layer 14.

### Total Thickness

An arrow TS in FIG. 3 represents the total thickness of the sheet 8. The total thickness TS is preferably 200 μm or more, more preferably 400 μm or more and particularly preferably 500 μm or more. This total thickness TS is preferably 5.0 mm or less, more preferably 3.0 mm or less and particularly preferably 1.0 mm or less. The distribution of the total thickness TS is preferably within a range of ±100 μm.

### Characteristics of Sheet

The water vapor transmittance of the sheet 8 is preferably 10 g/m²· day or more. After this sheet 8 is pasted to the roof 2, moisture contained in the roof 2 or moisture present between the roof 2 and the sheet 8 can be discharged through the sheet 8. This sheet 8 is capable of suppressing the corrosion of metal in the roof 2. This sheet 8 is also suitable for a structure that contains moisture (for example, a structure containing concrete that is not completely dried). This sheet 8 is also suitable for work in rainy weather. From these viewpoints, the water vapor transmittance is more preferably 20 g/m²· day or more and particularly preferably 25 g/m²· day or more. The water vapor transmittance is preferably 50 g/m²· day or less. The water vapor transmittance is measured in accordance with the prescriptions in “JIS Z0208.”

The peel strength of this sheet 8 in a 180° peel test is preferably 1.5 N/25 mm or higher. This sheet 8 is less likely to peel off from the roof 2 even under a strong wind. From this viewpoint, this peel strength is more preferably 5.0 N/25 mm or higher and particularly preferably 8.0 N/25 mm or higher.

The peel strength is measured by a 180° peel test in accordance with the prescription in “JIS Z 0237: 2022.” The details of a test piece are as described below. Production of test piece: In accordance with the prescription of Section “10.1” in “JIS Z 0237: 2022” PET film: 25 mm×200 mm, “T601E” manufactured by Mitsubishi Chemical Corporation, thickness: 50 μm) Double-sided adhesive tape: 25 mm×100 mm, “No. 5015” manufactured by Nitto Denko Technical Corporation Sheet: Cut out to 25 mm×100 mm Base: A steel plate (SUS30) prescribed in Section “10.2.2” of “JIS Z 0237: 2022”, surface finish: BA (BASUS sheet), 75 mm×150 mm

A test piece for measuring the peel strength is created by the following procedure.
(1) The surface of a BASUS plate is cleaned with MEK-applied BEMCOT (M-3II manufactured by Asahi Kasei Corporation)
(2) One adhesive surface of double-sided adhesive tape is pasted to the front-side surface of the sheet with a tape press roll (mass: 2 kg).
(3) The PET film is pasted to the other adhesive surface of the double-sided adhesive tape with the tape press roll (mass: 2 kg) such that the short sides are aligned.
(4) The adhesive layer of the sheet is pasted to the BASUS plate with the tape press roll (mass: 2 kg).

A test piece obtained by this procedure is preserved for 24 hours under an environment of normal temperature and normal humidity (23±2° C., 50±10% RH).

A test is performed in accordance with the prescription of Section “11.5” of “JIS Z 0237: 2022.” Measurement conditions are as described below.
Load cell: 1 kN
Temperature: 23±2° C.
Relative humidity: 50±5% RH
Speed: 300 mm/min
Peel length: 100 mm

A measurement value obtained until the length after the beginning of the measurement reaches 30 mm is ignored. Measurement values obtained when 30 mm of the sheet has peeled afterwards are averaged. As a device suitable for the test, product name “AUTOGRAPH AGX-V 10 kN” manufactured by Shimadzu Corporation is exemplified.

### Method for Manufacturing Sheet

Hereinafter, one example of a method for manufacturing this sheet 8 will be described. In this manufacturing method, a first coating material is obtained by mixing the polymer composition of the functional layer 10 with a solvent. A first coating film is obtained by applying this first coating material onto a base film. The solvent is volatilized from the first coating material by heating this first coating film. The base polymer is cured by this heating, and the functional layer 10 is obtained. The functional layer 10 having a roughness pattern can be obtained by applying the first coating material to a base film having a roughness pattern on the surface. The roughness pattern of the functional layer 10 has an inverted shape of the shape of the roughness pattern of the base film.

Next, a second coating material is obtained by mixing the composite material of the intermediate layer 12 with a solvent. A second coating film is obtained by applying this second coating material onto the functional layer 10. The reinforcing body 16 is pressed onto the second coating film. The solvent is volatilized from the second coating material by heating this second coating film. The polymer is cured by this heating, and the intermediate layer 12 including the reinforcing body 16 is obtained.

Next, a third coating material is obtained by mixing the adhesive composition of the adhesive layer 14 with a solvent. A third coating film is obtained by applying this third coating material onto a release film. The solvent is volatilized from the third coating material by heating this third coating film, and the adhesive layer 14 is obtained.

This adhesive layer 14 is overlapped onto the intermediate layer 12. Furthermore, the base film is peeled off from the functional layer 10, and the release film is peeled off from the adhesive layer 14, whereby the structure sheet 8 is obtained. The base film or the release film may remain on the structure sheet 8.

### Repair or Reinforcement of Roof

In the repair of the roof 2 with the above-described cladding structure 4, first, a deposit is removed from the surface of the roof 2, and the coating composition is then applied to this surface. This coating composition is dried, whereby the primer layer 6 is obtained. Next, the sheet 8 is pasted to the primer layer 6 by the adhesive force of the adhesive layer 14 of this sheet 8. After these steps, the cladding structure 4 is completed. The roof 2 for which no repair is required may be reinforced by forming the cladding structure 4 on the roof 2.

This sheet 8 has excellent conformability and can be thus applied to the roof 2 having a level difference as described above. The surface of the roof 2 is covered with a plurality of the sheets 8 over a large area by pasting the sheets 8 together. The sheet 8 has the adhesive layer 14, and the application of an adhesive (or bonding adhesive) to the roof 2 is thus not essential. Since this adhesive layer 14 has excellent adhesion, the surface of the roof 2 can be covered with the sheet 8 over a large area even when the material of the surface of the roof 2 is a composite material. For example, even when the roof 2 includes both metal and artificial slate on the surface, the surface of the roof 2 can be covered with the sheet 8 over a large area.

The entire surface of the roof 2 may be covered with the sheet 8. In the present specification, the surface of the roof 2 means a surface visible when the roof 2 is seen from above in the vertical direction. Repair in which the entire surface of the roof 2 is covered with a single kind of the sheet 8 is not found in conventional methods.

This sheet 8 is more lightweight than steel plates, copper plates, galvanized iron plates, and the like. Therefore, even when the surface of the roof 2 is covered with the sheet 8 over a large area, an adverse effect on the earthquake resistance of the building is small. From the viewpoint of earthquake resistance, the density of the sheet 8 is preferably 4.0 g/cm3 or lower, more preferably 3.0 g/cm3 or lower and particularly preferably 2.5 g/cm3 or lower. This density is much lower than the density of an aluminum-zinc alloy-plated steel plate (product name “GALVALUME steel plate”), which is commonly used in the repair of the roof 2.

### Adhesion Workload of Cladding Structure

An adhesion workload W2 between the primer layer 6 and the adhesive layer 14 is smaller than an adhesion workload W1 between a structure such as the roof 2 and the primer layer 6. In this cladding structure 4, when the sheet 8 is pasted to the primer layer 6, and this sheet 8 is then peeled off from the roof 2, peeling occurs in the interface between the primer layer 6 and the adhesive layer 14. In other words, when the sheet 8 is peeled off, peeling in the interface between the primer layer 6 and the adhesive layer 14 is suppressed. In this cladding structure 4, damage of the roof 2 when the sheet 8 peels off is suppressed. Furthermore, in this cladding structure 4, the scattering of dust derived from the roof 2 when the sheet 8 is peeled off is suppressed. From these viewpoints, the ratio (W1/W2) of the adhesion workload W1 to the adhesion workload W2 is preferably 1.20 or more, more preferably 1.23 or more and particularly preferably 1.25 or more. An appropriate ratio (W1/W2) can be achieved by obtaining the primer layer 6 from the above-described coating composition.

The adhesion workload correlates with surface free energy. The adhesion workload W between a first solid and a second solid is calculated by the following formula.

$$W = 2 {( {γ}_{SV 1}^{d} {γ}_{SV 2}^{d} )}^{1 / 2} + 2 {( {γ}_{SV 1}^{h} {γ}_{SV 2}^{h} )}^{1 / 2}$$

Y_{SV1}^{d}: A dispersion component of the surface free energy of the first solid
Y_{SV2}²: A dispersion component of the surface free energy of the second solid
Y_{SV1}^{h}: A hydrogen bond component of the surface free energy of the first solid
Y_{SV2}^{h}: A hydrogen bond component of the surface free energy of the second solid

In the present specification, liquid droplets of water and liquid droplets of methylene iodide are used in the measurement of the surface free energy. The surface free energy Y_{L1V1} of water is 72.8 mJ/m². This surface free energy Y_{LV1} is calculated by the following formula.

$${γ}_{LV 2} = {γ}_{LV 2}^{d} + {γ}_{LV 2}^{h}$$

Y_{LV1}^{d}: A dispersion component of the surface free energy
Y_{LV1}^{h}: A hydrogen bond component of the surface free energy

The surface free energy Y_{LV2} of methylene iodide is 50.8 mJ/m². This surface free energy Y_{LV2} is calculated by the following formula.

$$γ LV 1 = {γ}_{LV 1}^{d} + {γ}_{LV 1}^{h}$$

Y_{LV2}^{d}: A dispersion component of the surface free energy
Y_{LV2}^{h}: A hydrogen bond component of the surface free energy

When the contact angle of water with the solid is indicated by θ1, and the contact angle of methylene iodide with the solid is indicated by θ2, the following formula is established.

$${( {γ}_{sv}^{d} {γ}_{LV 1}^{d} )}^{1 / 2} + {( {γ}_{sv}^{h} {γ}_{LV 1}^{h} )}^{1 / 2} = ( {γ}_{L 1} ( 1 + cos θ1 ) ) / 2$$

$${( {γ}_{sv}^{d} {γ}_{LV 2}^{d} )}^{1 / 2} + {( {γ}_{sv}^{h} {γ}_{LV 2}^{h} )}^{1 / 2} = ( {γ}_{L 2} ( 1 + cos θ2 ) ) / 2$$

Y_{SV}^{d} and Y_{SV}^{h} of the solid can be calculated by assigning the contact angles θ1 and θ2 with the solid in the formula. A specimen for the measurement of the contact angle is obtained by applying the coating composition onto a 188 μm-thick PET film (trade name “COSMOSHINE A4300” manufactured by Toyobo Co., Ltd.). For the application, an applicator is used. The application amount is 400 g/m². This coating composition is held at a temperature of 100° C. for five minutes. As a result, the coating composition is dried, and a specimen is obtained.

In the present specification, the contact angle (θ1 or θ2) is measured under an environment of 23° C. 2 μL of liquid droplets (of water or methylene iodide) are added dropwise onto the solid. The angle formed by these solid and liquid is measured. As a device suitable for the measurement, a portable contact angle meter “PCA-11” manufactured by Kyowa Interface Science Co., Ltd. is exemplified.

### [Peel Strength of Cladding Structure]

The 180° peel force between the adhesive layer 14 and the primer layer 6 is preferably 1.5 N/25 mm or higher. The sheet 8 including the adhesive layer 14 having a peel strength of 1.5 N/25 mm or higher can be firmly joined to the roof 2. From this viewpoint, this peel force is more preferably 7 N/25 mm or higher and particularly preferably 11 N/25 mm or higher. This peel force is measured in accordance with the prescription of “JIS Z θ237 (2022)” described above. Instead of the BASUS plate, a base composed of a BASUS plate and the primer layer 6 can be used.

### [Other Uses of Cladding Structure]

These primer layer 6 and sheet 8 are capable of contributing to the repair or reinforcement of structures other than the roof 2. Examples of the structures other than the roof 2 include residential walls, pillars, eaves, fences, gates, doors, parapets, copings, and the like. These primer layer 6 and sheet 8 may also be used in commercial buildings, factories, warehouses, bridges, sewage facilities, railway facilities, utility poles, tunnels, and the like.

### [Re-Repair and Re-Reinforcement]

After the structure (the roof 2 or the like) is repaired or reinforced with this sheet 8 or a different sheet, the sheet or the structure may break or may deteriorate due to aging. The primer layer 6 can be formed by applying the above-described coating composition to this broken place or deterioration place in the sheet. Re-repair or re-reinforcement of the structure can be performed by pasting a new sheet 8 to this primer layer 6. The new sheet 8 is pasted to the old sheet, whereby the value of the structure can be preserved and maintained for an extremely long period of time. This pasting can be achieved by the bonding adhesive force of the primer layer 6. In this re-repair and re-reinforcement, there is no need to discard the old sheet. In this re-repair and re-reinforcement, waste generation can be suppressed. This primer layer 6 is in line with the gist of a circular economy. Since the new sheet 8 has a low density, an adverse effect on the earthquake resistance of the structure is small even when this new sheet 8 is laminated on the old sheet.

### EXAMPLES

Hereinafter, the effects of sheets according to examples will be clarified. The scope of the present specification should not be construed as being limited based on the description of these examples.

### Experiment 1 Coating Composition

### Example 1

19.9 Parts by mass of trimethylolpropane triglycidyl ether (trade name “DENACOL EX-321L” manufactured by Nagase ChemteX Corporation) as an epoxy compound, 53.9 parts by mass of 3-aminopropyltrimethoxysilane (Tokyo Chemical Industry Co., Ltd.) as an aminosilane compound and 26.2 parts by mass of 3-glycidyloxypropyltrimethoxysilane (Tokyo Chemical Industry Co., Ltd.) as an alkoxysilane-containing epoxy compound were injected into a Pyrex glass separable flask. These compounds were mixed together for 2.5 hours under a nitrogen stream that was at 60° C. and at normal pressure, and a reaction was made to progress. 100 Parts by mass of ethanol 100 was added thereto to terminate the reaction, thereby obtaining a partial reaction product having a gel fraction of 50%.

100 Parts by mass of a polymer including an alkyl (meth)acrylate ester monomer unit in the main chain (“DIANAL BR105” manufactured by Mitsubishi Chemical Corporation, weight-average molecular weight: 45000) was dissolved in 100 parts by mass of ethanol, thereby obtaining a solution of an acrylic resin. 25 Parts by mass of the partial reaction product and 100 parts by mass of the solution of an acrylic resin (100 parts by mass in terms of the solid content) were kneaded together with a ball mill, thereby obtaining a coating composition.

### Example 2

A coating composition was obtained in the same manner as in Example 1 except that 100 parts by mass of the solution of an acrylic resin and 10 parts by mass of the partial reaction product were kneaded together.

### Example 3

A coating composition was obtained in the same manner as in Example 1 except that 100 parts by mass of the solution of an acrylic resin and 90 parts by mass of the partial reaction product were kneaded together.

### Example 4

A coating composition was obtained in the same manner as in Example 1 except that the reaction time under the nitrogen stream was set to 1.0 hour. A partial reaction product having a gel fraction of 35% was obtained from this reaction.

### Example 5

A coating composition was obtained in the same manner as in Example 1 except that the reaction time under the nitrogen stream was set to 4.0 hours. A partial reaction product having a gel fraction of 60% was obtained from this reaction.

### Comparative Example 1

100 Parts by mass of a polymer including an alkyl (meth)acrylate ester monomer unit (“DIANAL BR105” described above) was dissolved in 100 parts by mass of ethanol, thereby obtaining a coating composition.

### Comparative Example 2

66.7 Parts by mass of an epoxy resin (trade name “E2300 base agent” manufactured by Konishi Co., Ltd.) and 33.3 parts by mass of a polyamideamine-modified aliphatic polyamine (“E2300 curing agent” manufactured by Konishi Co., Ltd.) were mixed together, thereby obtaining a coating composition.

### Comparative Example 3

19.9 Parts by mass of trimethylolpropane triglycidyl ether (trade name “DENACOL EX-321L” manufactured by Nagase ChemteX Corporation described above), 53.9 parts by mass of 3-aminopropyltrimethoxysilane (Tokyo Chemical Industry Co., Ltd.) and 26.2 parts by mass of 3-glycidyloxypropyltrimethoxysilane (Tokyo Chemical Industry Co., Ltd.) were injected into a container. These compounds were stirred at a temperature of 23° C. for 30 minutes, thereby obtaining a mixture. This mixture had a gel fraction of 0%, 25 Parts by mass of this mixture and 100 parts by mass of the solution of an acrylic resin used in Example 1 were kneaded together with the ball mill, thereby obtaining a coating composition.

### Test Piece for Evaluation

Artificial slate (trade name “COLONIAL-GLASSA” manufactured by KMEW Co., Ltd.) was irradiated with xenon light with a weather meter. Irradiation conditions were as described below.
Weather meter: Super xenon weather meter (“SX-75” manufactured by Suga Test Instruments Co., Ltd.)
Black panel temperature: 63° C.
Humidity: 55%
Irradiance: 180 W/m²@300 to 400 nm
Irradiation time: 5000 hr

The coating composition was applied to this artificial slate. The application amount was 200 g/m². This coating composition was dried at a temperature of 23° C. until the coating composition became dust-free and lost tackiness, and a primer layer having a thickness of 80 μm was obtained.

### [Production of Sheet]

A coating material containing an acrylic silicone-based resin was applied to release paper that was made of PP-laminated paper and had a thickness of 130 μm. This coating material was an emulsion composition containing 60 parts by mass of an acrylic silicone resin, 25 parts by mass of titanium dioxide, 10 parts by mass of ferric oxide and 5 parts by mass of carbon black. This coating material was dried, thereby obtaining a functional layer having a thickness of 100 μm.

A different coating material was applied to this functional layer. This coating material was a water-based acrylic emulsion containing 45 parts by mass of a cement mixture. The cement mixture contained 70±5 parts by mass of Portland cement, 10±5 parts by mass of silicon dioxide, 2±1 parts by mass of aluminum oxide and 1 to 2 parts by mass of titanium oxide. The acrylic emulsion contained 53±2 parts by mass of an acrylic acid-based polymer obtained by emulsion polymerization using an acrylic acid ester monomer as an emulsifier and 43±2 parts by mass of water. This coating material was dried to obtain an intermediate layer (polymer-cement-cured layer). In this intermediate layer, the Portland cement had dispersed in the acrylic resin. The content rate of the Portland cement was 50 mass %.

Cheesecloth having a mesh count of 520 (trade name “V520” manufactured by UNITIKA Trading Co., Ltd., thickness: 220 μm, material: vinylon, basis weight: 32 g/m²) was laminated on this intermediate layer. The total thickness of the intermediate layer and the cheesecloth was 300 μm.

A mixed solution for an adhesive was prepared by mixing 100 parts by mass of an acrylic adhesive (product name “ORIBAIN 6574” described above) and 6 parts by mass of an isocyanate-based curing agent (product name “BHS 8515”, manufactured by TOYOCHEM CO., LTD.) together. This mixed solution for an adhesive was applied to the surface of the cheesecloth. This mixed solution was dried to form an adhesive layer having a thickness of 200 μm, thereby obtaining a sheet having a total thickness of 600 μm.

### [Initial Bonding Adhesion]

The sheet was pasted to the primer layer with a press roll having a mass of 2 kg. Double-sided adhesive tape (trade name “No. 5015” manufactured by Nitto Denko Technical Corporation) was pasted to the surface of the functional layer in this sheet. A film that had a thickness of 100 μm and was made of PET was pasted to the surface of this adhesive tape, thereby obtaining a laminate. After 24 hours, this laminate was subjected to a 180° peel test. Testing conditions are as described below.
Width of test piece: 25 mm
Temperature: 23° C.
Humidity: 50%
Tester: AUTOGRAPH (“AGX-V 10 kN” manufactured by Shimadzu Corporation)
Peeling speed: 300 mm/min

These results are shown on Tables 1 and 2 below.

### [Long-Term Bonding Adhesion]

A test piece obtained by the same method as for the test piece used in the evaluation of the initial bonding adhesion was irradiated with xenon light with a weather meter.
Irradiation conditions are as described below.
Weather meter: Super xenon weather meter (“SX-75” manufactured by Suga Test Instruments Co., Ltd.)
Black panel temperature: 63° C.
Humidity: 55%
Irradiance: 180 W/m²@300 to 400 nm
Irradiation time: 5000 hr

This test piece was subjected to a 180° peel test. Testing conditions were the same as the conditions for the 180° peel test for the initial bonding adhesion. These results are shown on Tables 1 and 2 below.

### [Sealing Property]

The sheet was pasted to the primer layer. After 30 minutes, the sheet was peeled off from the base. The peeling state was visually observed and rated according to the following standards.
A: Peeling occurs in the interface between the sheet and the primer layer (cohesion failure).
B: Peeling occurs in the interface between the primer layer and the artificial slate (interfacial failure).

These results are shown on Tables 1 and 2 below.

### [Workability]

Time taken for the coating composition to dry in the above-described formation of the primer layer was measured. These results are shown on Tables 1 and 2 below.

### [Pot Life]

The coating composition for the primer layer was held at a temperature of 23° C. for five hours. The occurrence of gelation was confirmed every hour. Time taken for gelation to occur is the pot life. These results are shown on Tables 1 and 2 below.

### [Insect Repellency]

The artificial slate covered with the primer layer was held outdoors for two hours, and the number of insects (bees or the like) gathering on the primer layer was counted and rated according to the following standards.
A: The number of insects is nine or less.
B: The number of insects is 10 or more.

These results are shown on Tables 1 and 2 below.

TABLE 1
Evaluation results

| | Exam- | Exam- | Exam- | Exam- |
|---|---|---|---|---|
| | ple 1 | ple 2 | ple 3 | ple 4 |
| 50% solution of acrylic | 100 | 100 | 100 | 100 |
| polymer (1) | | | | |
| [parts by mass] | | | | |
| Partial reaction product (2) | 25 | 10 | 90 | 25 |
| [parts by mass] | | | | |
| Unreacted mixture [parts by | — | — | — | — |
| mass] | | | | |
| Gel fraction [%] | 50 | 50 | 50 | 35 |
| Epoxy resin | — | — | — | — |
| Initial bonding adhesion | 23.3 | 24.8 | 20.4 | 17.3 |
| [N/25 mm] | | | | |
| Long-term bonding adhesion | 25.4 | 26.3 | 21.8 | 19.1 |
| [N/25 mm] | | | | |
| Sealing property | A | A | A | A |
| Workability [hr] | 0.5 | 0.5 | 0.5 | 0.5 |
| Pot life [hr] | No | No | No | No |
| | gelation | gelation | gelation | gelation |
| Insect repellency | A | A | A | A |

TABLE 2
Evaluation results

| | | Compar- | Compar- | Compar- |
|---|---|---|---|---|
| | | ative | ative | ative |
| | Exam- | Exam- | Exam- | Exam- |
| | ple 5 | ple 1 | ple 2 | ple 3 |
| 50% solution of | 100 | 100 | — | 100 |
| acrylic polymer (1) | | | | |
| [parts by mass] | | | | |
| Partial reaction | 25 | — | — | — |
| product (2) [parts | | | | |
| by mass] | | | | |
| Unreacted mixture | — | — | — | 25 |
| [parts by mass] | | | | |
| Gel fraction [%] | 60 | — | — | 0 |
| Epoxy resin | — | — | 100 | — |
| Initial bonding | 18.9 | 25.1 | 15.7 | 21.3 |
| adhesion [N/25 mm] | | | | |
| Long-term bonding | 20.2 | 26.2 | 16.6 | 23.3 |
| adhesion [N/25 mm] | | | | |
| Sealing property | A | B | A | A |
| Workability [hr] | 0.5 | 0.5 | 6.0 | 0.5 |
| Pot life [hr] | No | No | 3.0 | No |
| | gelation | gelation | | gelation |
| Insect repellency | A | B | A | A |

As is evident from Tables 1 and 2, the coating composition of each example is excellent in terms of a variety of performances. The advantages of these coating compositions are evident from these evaluation results.

### Experiment 2 Cladding Structure

### Example 6

An aluminum-zinc alloy-plated steel plate (flat GALVALUME steel plate manufactured by Q-ho Metal Works) was prepared. A plating layer in this steel plate contained 55.0 mass % of Al, 43.4% of Zn and 6.0% of Si. For this steel plate, the contact angle θ1 was 77.5°, the contact angle θ2 was 45.4°, Y_{SV}^{d} was 33.1 mJ/m², Y_{SV}^{h} was 6.0 mJ/m², and the surface free energy y was 39.1 mJ/m². The coating composition of Example 1 was applied to this steel plate (adherend). The application amount was 400 g/m². This coating composition was held at a temperature of 100° C. for five minutes and dried, thereby obtaining a primer layer. Incidentally, a sheet shown in FIGS. 1 to 3 was prepared. This sheet had an adhesive layer. This adhesive layer was obtained from an adhesive composition (“ORIBAIN BPS 5565K” described above). For this adhesive layer, the contact angle θ1 was 108.6°, the contact angle θ2 was 60.5°, Y_{SV}^{d} was 29.5 mJ/m², Y_{SV}^{h} was 0 mJ/m², and the surface free energy Y was 29.5 mJ/m².

### Examples 7 and 8 and Comparative Examples 4 to 6

Cladding structures were obtained in the same manner as in Example 6 except that the composition for the primer layer was changed as shown in Tables 3 and 4 below. The details of the compositions are as described below.

Comparative Example 4: A coating composition containing an acrylic silicone resin as a base material (product name “Belle Earth Elastic Black” manufactured by Fujikura Kasei Co., Ltd.)

Comparative Example 5: A mixture (mass mixing ratio: 50/50) of a coating composition containing an acrylic silicone resin as a base material (“Belle Earth Elastic Black” described above) and another coating composition containing an acrylic silicone resin as a base material (product name “CL-CB1 BLACK (P5)” manufactured by Dainichiseika Color & Chemicals Mfg. Co., Ltd.)

Example 7: A mixture (mass mixing ratio: 50/50) of a water-based aluminum hydroxide dispersion body (product name “9216AO” manufactured by Tokushiki Co., Ltd.) and an ethylene-vinyl acetate copolymer (product name “SUMIKAFLEX S-400HQ” manufactured by Sumika Chemtex Co., Ltd.)

Example 8: A mixture (mass mixing ratio: 50/50) of a water-based aluminum hydroxide dispersion body (“9216AO” described above) and the coating composition of Example 1

Comparative Example 6: A coating composition containing a silicone resin as a base material (product name “SK PREMIUM SILICONE” manufactured by SK KAKEN Co., Ltd.)

### Peel Test

The cladding structure was subjected to a peel test. A peeling place was visually observed, and the peeling interface was determined. These results are shown on Tables 3 and 4 below.

TABLE 3
Evaluation results

| | | Comparative | Comparative |
|---|---|---|---|
| | Example 6 | Example 4 | Example 5 |
| Component | Coating | Acrylic | Acrylic |
| | material of | silicone | silicone |
| | Example 1 | | |
| θ1 [degree] | 75.9 | 120.3 | 92.4 |
| θ2 [degree] | 39.7 | 55.6 | 55.6 |
| γsv^{d} | 36.0 | 26.0 | 29.5 |
| γsv^{h} | 5.8 | 0.0 | 1.8 |
| γ | 41.8 | 26.0 | 31.3 |
| Adhesion workload [mJ/w²] | | | |
| Adherend/primer layer | 80.8 | 58.7 | 69.1 |
| W1 | | | |
| Primer layer/adhesive layer | 64.4 | 54.7 | 58.3 |
| W2 | | | |
| Ratio (W1/W2) | 1.25 | 1.07 | 1.19 |
| Peeling interface | Primer layer/ | Adherend/ | Adherend/ |
| | adhesive layer | primer layer | primer layer |
| Peeling between | No | Yes | Yes |
| adherend and primer layer | | | |

TABLE 4
Evaluation results

| | | | Comparative |
|---|---|---|---|
| | Example 7 | Example 8 | Example 6 |
| Component | Aluminum | Aluminum | Hybrid |
| | hydroxide/ | hydroxide/ | silicone |
| | EVA | coating | |
| | | material of | |
| | | Example1 | |
| θ1 [degree] | 40.9 | 71.4 | 115.6 |
| θ2 [degree] | 16.5 | 37.7 | 58.0 |
| γsv^{d} | 39.5 | 36.2 | 26.9 |
| γsv^{h} | 23.0 | 7.8 | 0.0 |
| γ | 62.5 | 44.0 | 26.9 |
| Adhesion workload | | | |
| [mJ/w²] | | | |
| Adherend/primer layer | 48.0 | 41.4 | 29.8 |
| W1 | | | |
| Primer layer/adhesive | 34.1 | 32.7 | 28.2 |
| layer W2 | | | |
| Ratio (W1/W2) | 1.41 | 1.27 | 1.06 |
| Peeling interface | Primer layer/ | Primer layer/ | Adherend/ |
| | adhesive layer | adhesive layer | primer layer |
| Peeling between | No | No | Yes |
| adherend and primer | | | |
| layer | | | |

As is evident from Tables 3 and 4, in the cladding structure of each example, peeling occurs in the interface between the primer layer and the adhesive layer. The advantages of these cladding structures are evident from these evaluation results.

### [Disclosed Items]

Each of the following items discloses a preferred embodiment.

### [Item 1]

A coating composition containing (1) a polymer including an alkyl (meth)acrylate ester monomer unit in a main chain thereof,

and
(2) a partial reaction product of a mixture containing an epoxy compound and an aminosilane compound.

### [Item 2]

The coating composition according to Item 1, in which, in the partial reaction product (2), gelation by a reaction between the epoxy compound and the aminosilane compound does not occur.

### [Item 3]

The coating composition according to Item 1 or 2, in which an amount of the partial reaction product (2) is 1 part by mass or more and 150 parts by mass or less with respect to 100 parts by mass of the polymer (1).

### [Item 4]

The coating composition according to any one of Items 1 to 3, in which a ratio (Y/X) of the number (Y) of amino groups and/or imino groups in the aminosilane compound to the number (X) of epoxy groups in the epoxy compound in the mixture is 0.2 or more and 1.5 or less.

### [Item 5]

The coating composition according to any one of Items 1 to 4, in which the mixture further contains an alkoxysilane-containing epoxy compound.

### [Item 6]

The coating composition according to Item 5, in which a ratio of an amount of the alkoxysilane-containing epoxy compound to a total amount of the epoxy compound, the aminosilane compound and the alkoxysilane-containing epoxy compound in the mixture is 10 mass % or more and 40 mass % or less.

### [Item 7]

A method for manufacturing a coating composition, including: A: a step of preparing a mixture containing an epoxy compound and an aminosilane compound,
B: a step of reacting the mixture,
C: a step of terminating a reaction of the mixture before gelation by a reaction between the epoxy compound and the aminosilane compound occurs to obtain a partial reaction product,
and
D: a step of mixing a polymer including an alkyl (meth)acrylate ester monomer unit in a main chain and the partial reaction product together.

### [Item 8]

A method for protecting a structure, including: A: a step of applying a coating composition containing a polymer including an alkyl (meth)acrylate ester monomer unit in a main chain and a partial reaction product of a mixture containing an epoxy compound and an aminosilane compound to a surface of a structure to obtain a primer layer,
and
B: a step of pasting a sheet having a functional layer and an adhesive layer to the primer layer by an adhesive force of the adhesive layer.

### [Item 9]

The protection method according to Item 8, in which, in the step B, a sheet in which a material of the adhesive layer is an adhesive composition and a base material of this composition is an acrylic resin is pasted to the primer layer.

### [Item 10]

The protection method according to Item 8 or 9, in which, in the step B, a sheet in which an intermediate layer is provided between the functional layer and the adhesive layer and this intermediate layer contains a polymer and cement that disperses in a matrix of this polymer is pasted to the primer layer.

### [Item 11]

A structure cladding structure including a primer layer that is positioned on a structure, an adhesive layer that is positioned on this primer layer, and a functional layer that is positioned on this adhesive layer,
in which an adhesion workload W2 between the primer layer and the adhesive layer is smaller than an adhesion workload W1 between the structure and the primer layer, and a ratio (W1/W2) of the adhesion workload W1 to the adhesion workload W2 is 1.20 or more.

### [Item 12]

The cladding structure according to Item 11, in which a 180° peel force between the primer layer and the adhesive layer measured in accordance with a prescription in JIS Z θ237 (2022) is 1.51 N/25 mm or higher.

### INDUSTRIAL APPLICABILITY

The coating composition thus described can be used as a primer for a variety of structures.

### REFERENCE SIGNS LIST

2 Roof
4 Cladding structure
6 Primer layer
8 Sheet
10 Functional layer
12 Intermediate layer
14 Adhesive layer
16 Reinforcing body
18 Thread
18a Warp thread
18b Weft thread
20 Mesh

1. A structure cladding structure comprising:
a primer layer that is positioned on a structure;
an adhesive layer that is positioned on this primer layer; and
a functional layer that is positioned on this adhesive layer,
wherein an adhesion workload W2 between the primer layer and the adhesive layer is smaller than an adhesion workload W1 between the structure and the primer layer, and a ratio (W1/W2) of the adhesion workload W1 to the adhesion workload W2 is 1.20 or more.

2. The cladding structure according to claim 1, wherein a 180° peel force between the primer layer and the adhesive layer measured in accordance with a prescription in JIS Z θ237 (2022) is 1.51 N/25 mm or higher.

3. A coating composition comprising:
(1) a polymer including an alkyl (meth)acrylate ester monomer unit in a main chain thereof;
and
(2) a partial reaction product of a mixture containing an epoxy compound and an aminosilane compound.

4. The coating composition according to claim 3, wherein, in the partial reaction product (2), gelation by a reaction between the epoxy compound and the aminosilane compound does not occur.

5. The coating composition according to claim 3, wherein an amount of the partial reaction product (2) is 1 part by mass or more and 150 parts by mass or less with respect to 100 parts by mass of the polymer (1).

6. The coating composition according to claim 3, wherein a ratio (Y/X) of the number (Y) of an amino group and/or an imino group in the aminosilane compound to the number (X) of an epoxy group in the epoxy compound in the mixture is 0.2 or more and 1.5 or less.

7. The coating composition according to claim 3, wherein the mixture further contains an alkoxysilane-containing epoxy compound.

8. The coating composition according to claim 7, wherein a ratio of an amount of the alkoxysilane-containing epoxy compound to a total amount of the epoxy compound, the aminosilane compound and the alkoxysilane-containing epoxy compound in the mixture is 10 mass % or more and 40 mass % or less.

9. A method for manufacturing a coating composition, comprising:
A: a step of preparing a mixture containing an epoxy compound and an aminosilane compound;
B: a step of reacting the mixture;
C: a step of terminating a reaction of the mixture before gelation by a reaction between the epoxy compound and the aminosilane compound occurs to obtain a partial reaction product; and
D: a step of mixing a polymer including an alkyl (meth)acrylate ester monomer unit in a main chain and the partial reaction product together.

10. A method for protecting a structure, comprising:
A: a step of applying a coating composition containing a polymer including an alkyl (meth)acrylate ester monomer unit in a main chain and a partial reaction product of a mixture containing an epoxy compound and an aminosilane compound to a surface of a structure to obtain a primer layer;
and
B: a step of pasting a sheet having a functional layer and an adhesive layer to the primer layer by an adhesive force of the adhesive layer.

11. The protection method according to claim 10, wherein, in the step B, a sheet in which a material of the adhesive layer is an adhesive composition and a base material of this composition is an acrylic resin is pasted to the primer layer.

12. The protection method according to claim 10, wherein, in the step B, a sheet in which an intermediate layer is provided between the functional layer and the adhesive layer and this intermediate layer contains a polymer and cement that disperses in a matrix of this polymer is pasted to the primer layer.

13. The coating composition according to claim 4, wherein an amount of the partial reaction product (2) is 1 part by mass or more and 150 parts by mass or less with respect to 100 parts by mass of the polymer (1).

14. The coating composition according to claim 4, wherein a ratio (Y/X) of the number (Y) of an amino group and/or an imino group in the aminosilane compound to the number (X) of an epoxy group in the epoxy compound in the mixture is 0.2 or more and 1.5 or less.

15. The coating composition according to claim 4, wherein the mixture further contains an alkoxysilane-containing epoxy compound.

16. The protection method according to claim 11, wherein, in the step B, a sheet in which an intermediate layer is provided between the functional layer and the adhesive layer and this intermediate layer contains a polymer and cement that disperses in a matrix of this polymer is pasted to the primer layer.
